(19) United States
(12) Patent Application Publication
(10) Pub. No.: US 2025/0367940 A1
(43) Pub. Date: Dec. 4, 2025

(54) IMAGE FORMING APPARATUS, ORIENTATION ADJUSTMENT METHOD, AND IMAGE FORMING METHOD CAPABLE OF OUTPUTTING IMAGES ALLOWING EASY RECOGNITION OF INCLINATION OF EJECTION PORTION

(71) Applicant: KYOCERA Document Solutions Inc., Osaka (JP)

(72) Inventor: Yuki Shimizu, Osaka (JP)

(21) Appl. No.: 19/225,273

(22) Filed: Jun. 2, 2025

(30) Foreign Application Priority Data
Jun. 4, 2024 (JP) 2024-090778

(51) Int. Cl. B41J 2/21

(52) U.S. Cl. CPC B41J 2/2139; B41J 2/2135; B41J 2/2146

(57) ABSTRACT

An image forming apparatus includes an ejection portion, a first formation processing portion, and a second formation processing portion. The ejection portion has a plurality of nozzles arranged along a width direction of a recording medium. The first formation processing portion alternately ejects ink from first nozzles of the plurality of nozzles that are located farther on one side in the conveying direction of the recording medium than two adjacent nozzles adjacent in the width direction, and second nozzles of the two adjacent nozzles, to form first line images on the recording medium. The second formation processing portion alternately ejects ink from the first nozzles and third nozzles of the two adjacent nozzles that are different from the second nozzles, to form second line images on the recording medium.

### INCORPORATION BY REFERENCE

This application is based upon and claims the benefit of priority from the corresponding Japanese Patent Application No. 2024-090778 filed on June 4, 2024, the entire contents of which are incorporated herein by reference.

### BACKGROUND

The present disclosure relates to an image forming apparatus, an orientation adjustment method, and an image forming method.

An inkjet-type image forming apparatus includes an ejection portion such as a recording head. The ejection portion has a plurality of nozzles arranged along a width direction perpendicular to a conveying direction of a recording medium such as a sheet, and ejects ink from each of the nozzles toward the recording medium.

In addition, an image forming apparatus is disclosed in which a predetermined test pattern is printed using the ejection portion, and inclination of the ejection portion is acquired based on a human or machine evaluation of a printed result of the test pattern.

### SUMMARY

An image forming apparatus according to one aspect of the present disclosure includes an ejection portion, a first formation processing portion, and a second formation processing portion. The ejection portion has a plurality of nozzles arranged along a width direction perpendicular to a conveying direction of a recording medium, and ejects ink from each of the nozzles toward the recording medium. The first formation processing portion alternately ejects the ink from first nozzles of the plurality of nozzles located farther on one side in the conveying direction than two adjacent nozzles adjacent to each other in the width direction and second nozzles of either one of the two adjacent nozzles, to form first line images along the conveying direction on the recording medium. The second formation processing portion alternately ejects ink from the first nozzles and third nozzles of the two adjacent nozzles that are different from the second nozzles, to form second line images along the conveying direction on the recording medium.

An orientation adjustment method according to another aspect of the present disclosure is executed using the image forming apparatus, and includes an acquisition step and an adjustment step. In the acquisition step, an inclination angle of the ejection portion with respect to the width direction is acquired based on the first line images and the second line images formed on the recording medium. In the adjustment step, orientation of the ejection portion is adjusted based on the result acquired in the acquisition step.

An image forming method according to another aspect of the present disclosure is executed by an image forming apparatus including an ejection portion having a plurality of nozzles arranged along a width direction perpendicular to a conveying direction of a recording medium, and configured to eject ink from each of the nozzles toward the recording medium, and includes a first formation step and a second formation step. In the first formation step, the ink is alternately ejected from first nozzles of the plurality of nozzles located farther on one side in the conveying direction than two adjacent nozzles adjacent to each other in the width direction and second nozzles of either one of the two adjacent nozzles, to form first line images along the conveying direction on the recording medium. In the second formation step the ink is alternately ejected from the first nozzles and third nozzles of the two adjacent nozzles that are different from the second nozzles, to form second line images along the conveying direction on the recording medium.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus of an embodiment according to the present disclosure.

FIG. 2 is a plan view showing a configuration of an image forming portion and a conveying unit in an image forming apparatus of an embodiment according to the present disclosure.

FIG. 3 is a block diagram showing a system configuration of an image forming apparatus of an embodiment according to the present disclosure.

FIG. 4 is a diagram showing a plurality of nozzles provided in a recording head of an image forming apparatus of an embodiment according to the present disclosure, and first line images and second line images formed by the plurality of nozzles.

FIG. 5 is a diagram showing a plurality of nozzles provided in a recording head of an image forming apparatus of an embodiment according to the present disclosure, and first line images and a second line images formed by the plurality of nozzles.

FIG. 6 is a diagram showing a plurality of nozzles provided in a recording head of an image forming apparatus of an embodiment according to the present disclosure, and first line images and second line images formed by the plurality of nozzles.

FIG. 7 is a flowchart showing an example of an inclination angle acquisition process executed in the image forming apparatus of an embodiment according to the present disclosure.

### DETAILED DESCRIPTION

Hereinafter, embodiments according to the present disclosure will be described with reference to the accompanying drawings. Note that the following embodiments are examples of a technique according to the present disclosure and do not limit the technical scope of the present disclosure.

### Configuration of Image Forming Apparatus 100

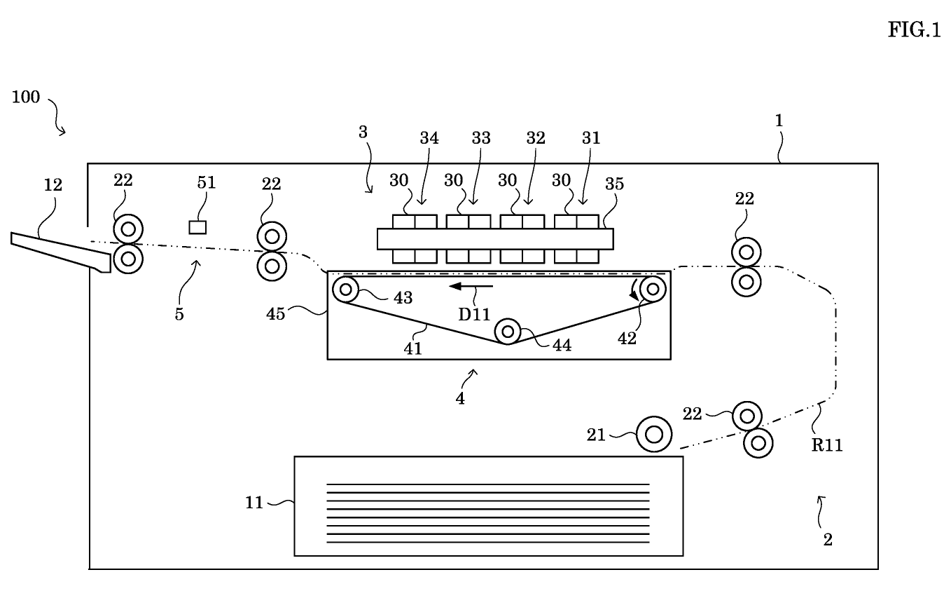

First, a configuration of an image forming apparatus 100 of an embodiment according to the present disclosure will be described with reference to FIGS. 1 to 4. Note that in FIG. 1, a sheet conveying path R11 is indicated by a two-dot chain line.

The image forming apparatus 100 is a printer capable of forming an image on a sheet (an example of a recording medium according to the present disclosure) by an inkjet method. Note that the recording medium according to the present disclosure is not limited to a sheet, and may be a cloth, a resin film, or the like. In addition, the technique according to the present disclosure may also be applied to a fax machine, a copier, or a multifunction peripheral capable of forming an image on a sheet by an inkjet method.

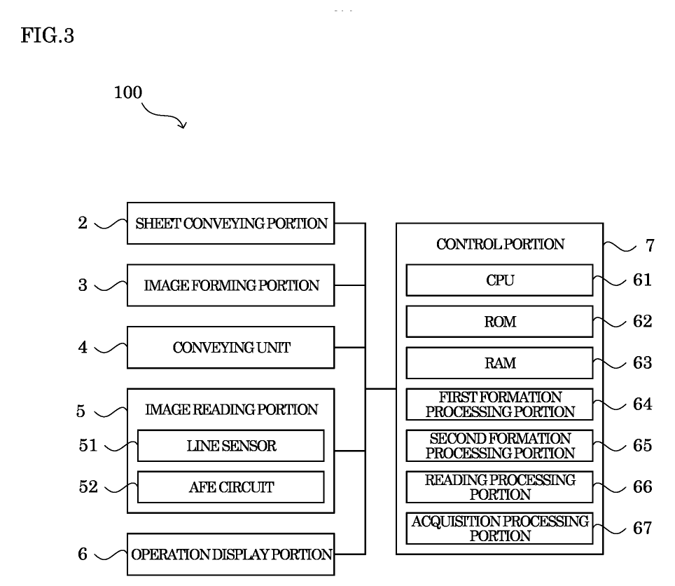

As shown in FIG. 1, the image forming apparatus 100 includes a housing 1, a sheet conveying portion 2, an image forming portion 3, a conveying unit 4, and an image reading portion 5. In addition, the image forming apparatus 100 further includes an operation display portion 6 and a control portion 7 shown in FIG. 3.

The housing 1 accommodates each of the components of the image forming apparatus 100. A sheet feed cassette 11 (see FIG. 1) is detachably provided in the housing 1. The sheet feed cassette 11 accommodates sheets on which images are to be formed. A sheet discharge tray 12 (see FIG. 1) is provided on an outer surface of the housing 1. A sheet on which an image has been formed by the image forming portion 3 is discharged to the sheet discharge tray 12. Inside the housing 1, sheets accommodated in the sheet feed cassette 11 are conveyed along a sheet conveying path R11 (see FIG. 1) that leads to the sheet discharge tray 12 via an image forming position of the image forming portion 3.

The sheet conveying portion 2 conveys sheets accommodated in the sheet feed cassette 11 along the sheet conveying path R11 (see FIG. 1). As shown in FIG. 1, the sheet conveying portion 2 includes a pick-up roller 21 and a plurality of conveying rollers 22. The pick-up roller 21 picks up the top sheet of the sheet stack accommodated in the sheet feed cassette 11, and feeds the sheet out to the sheet conveying path R11. The plurality of conveying rollers 22 are arranged side by side along the sheet conveying path R11. Each of the conveying rollers 22 conveys the sheet along the sheet conveying path R11. Each of the conveying rollers 22 conveys the sheet in a conveying direction D11 (see FIG. 1) from the sheet feed cassette 11 to the sheet discharge tray 12.

The image forming portion 3 forms an image on the sheet conveyed along the sheet conveying path R11 (see FIG. 1). As shown in FIG. 1, the image forming portion 3 includes line heads 31 to 34 and a head frame 35.

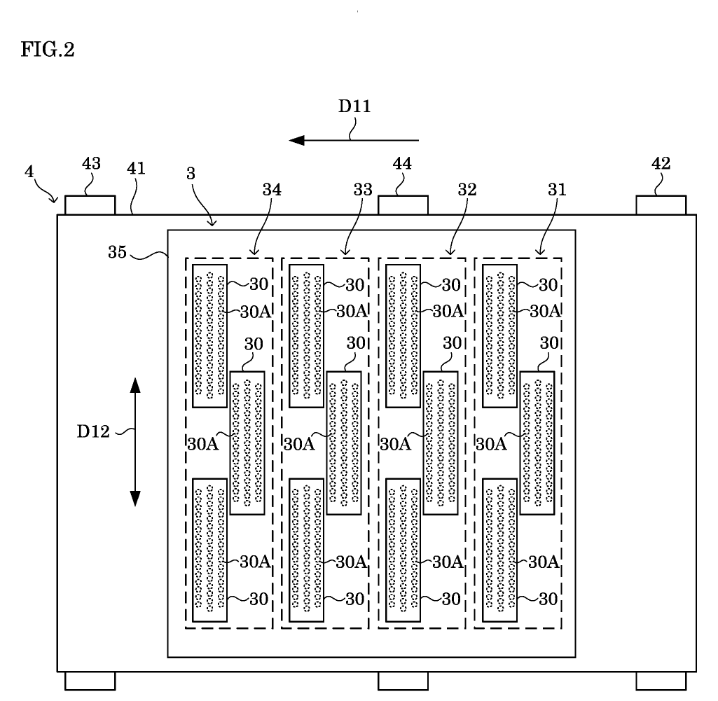

As shown in FIG. 2, each of the line heads 31 to 34 is elongated in a width direction D12 perpendicular to the conveying direction D11. More specifically, each of the line heads 31 TO 34 has a length in the width direction D12 that corresponds to a width of the largest size sheet that can be accommodated in the paper cassette 11. The line heads 31 TO 34 are arranged side by side at equal intervals along the conveying direction D11.

The line head 31 ejects black ink toward the sheet conveyed by the conveying unit 4. The line head 32 ejects cyan ink toward the sheet conveyed by the conveying unit 4. The line head 33 ejects magenta ink toward the sheet conveyed by the conveying unit 4. The line head 34 ejects yellow ink toward the sheet conveyed by the conveying unit 4.

The line heads 32 to 34 have a common configuration with the line head 31, except that the colors of the ejected inks are different. Hereinafter, only the line head 31 will be described.

As shown in FIG. 2, the line head 31 has three recording heads 30. Each of the recording heads 30 is elongated in the width direction D12. The three recording heads 30 are arranged in a staggered manner along the width direction D12.

The recording head 30 has a plurality of nozzles 30A (see FIG. 2) arranged along the width direction D12 perpendicular to a sheet conveying direction D11. The recording head 30 ejects ink from each of the nozzles 30A toward the sheet. The recording head 30 is an example of an ejection portion according to the present disclosure.

In the recording head 30, the plurality of nozzles 30A are arranged along the width direction D12 at a density corresponding to a printing resolution of the image forming apparatus 100.

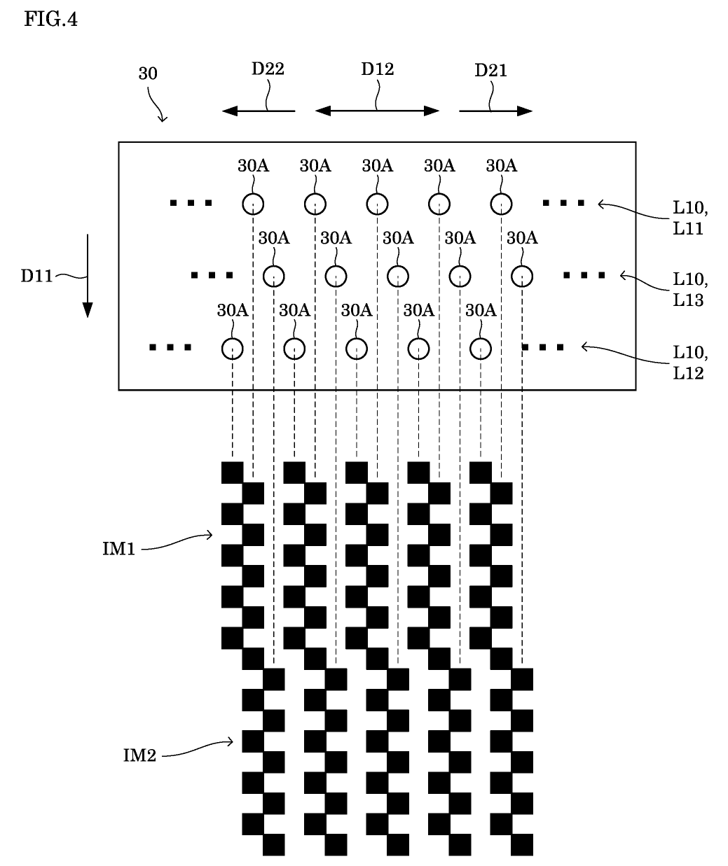

For example, as shown in FIG. 4, the recording head 30 includes three nozzle rows L10 (L11, L12,L13) formed by a plurality of nozzles 30A aligned along the width direction D12. In each nozzle row L10, a plurality of nozzles 30A are arranged side by side at intervals of two pixels of the printing resolution of the image forming portion 3. Three nozzle rows L10 are arranged in the conveying direction D11 in the following order: first nozzle row L11, third nozzle row L13, and second nozzle row L12. The first nozzle row L11 is arranged so as to be shifted by an amount of one pixel of the printing resolution of the image forming portion 3 toward a first direction D21 side (see FIG. 4) along the width direction D12 with respect to the second nozzle row L12. The third nozzle row L13 is arranged so as to be shifted by an amount of one pixel of the printing resolution of the image forming portion 3 toward the first direction D21 side with respect to the first nozzle row L11. The second nozzle row L12 is arranged so as to be shifted by an amount of one pixel of the printing resolution of the image forming portion 3 toward the first direction D21 side with respect to the third nozzle row L13.

All the nozzles 30A included in the line head 31 are arranged along the width direction D12. More specifically, the three recording heads 30 included in the line head 31 are arranged in a staggered pattern along the width direction D12 so that all the nozzles 30A included in the line head 31 are arranged at a density along the width direction D12 corresponding to the printing resolution of the image forming apparatus 100.

Each of the recording heads 30 includes a pressure chamber (not shown), an ejecting element (not shown), and an individual flow path (not shown) corresponding to each of the nozzles 30A. The pressure chamber communicates with the nozzles 30A and contains ink. The ejecting element ejects ink from the nozzle 30A in response to an input of a drive signal. For example, the ejecting element is a piezoelectric element. The ejecting element ejects ink from the nozzle 30A by changing the volume of the pressure chamber in response to input of the drive signal. The individual flow path is an ink flow path provided between the pressure chamber and a common flow path (not shown) shared by the plurality of nozzles 30A. The common flow path is connected to the plurality of individual flow paths corresponding to the plurality of nozzles 30A. The common flow path is connected to an ink supply portion (not shown) that supplies ink to each of the pressure chambers.

The head frame 35 supports the line heads 31 to 34. The head frame 35 is supported by the housing 1. Note that the number of line heads provided in the image forming portion 3 does not have to be four. In addition, the number of recording heads 30 provided in each of the line heads 31 to 34 does not have to be three.

As shown in FIG. 1, the conveying unit 4 is arranged below the line heads 31 to 34. The conveying unit 4 conveys the sheet while causing the sheet to face the recording heads 30. As shown in FIG. 1, the conveying unit 4 includes a conveying belt 41 on which a sheet is placed, a first tension roller 42, a second tension roller 43, and a third tension roller 44 that apply tension to the conveying belt 41, and a conveying frame 45 that supports these. Note that the gap between the conveying belt 41 and the recording heads 30 is adjusted so that the gap between the surface of the sheet and the recording heads 30 during image formation is a predetermined distance (for example, 1 mm).

The first tension roller 42 is rotationally driven by a rotational driving force supplied from a motor (not shown). Thus, the conveying belt 41 rotates in a direction capable of conveying the sheet in the conveying direction D11 (see FIG. 1). Note that the conveying unit 4 is also provided with a suction unit (not shown) that sucks air through a large number of through holes formed in the conveying belt 41 in order to suck and attach the sheet to the conveying belt 41.

The image reading portion 5 reads the image formed on the sheet by the image forming portion 3. The image reading portion 5 reads the image formed on the sheet at a reading resolution lower than the printing resolution of the image forming portion 3.

As shown in FIG. 3, the image reading portion 5 includes a line sensor 51 and an analog front end (AFE) circuit 52.

As shown in FIG. 1, the line sensor 51 is provided on the sheet conveying path R11 farther on the downstream side in the conveying direction D11 of the sheet than the image forming portion 3. The line sensor 51 is capable of reading an image of one line along the width direction D12 (see FIG. 2) from the sheet conveyed by the sheet conveying portion 2. For example, the line sensor 51 is a contact image sensor (CIS). The line sensor 51 includes a plurality of imaging elements arranged side by side in the width direction D12. Each of the imaging elements includes a light emitting portion and a light receiving portion. The light emitting portion emits light toward the sheet being conveyed by the sheet conveying portion 2. The light receiving portion is provided to be able to receive light emitted from the light emitting portion and reflected by the sheet, and outputs an analog electrical signal according to the amount of received light. The line sensor 51 outputs analog electrical signals corresponding to one line portions of an image at predetermined intervals in response to a control signal input from the control portion 7.

The AFE 52 is an electronic circuit that executes a predetermined process on the analog electrical signal output from the line sensor 51. More specifically, the AFE 52 includes a signal conversion portion that converts the analog electrical signal output from the line sensor 51 into a digital electrical signal (image data). In addition, the AFE 52 also includes an image processing portion that executes predetermined image processing such as shading correction on the image data output from the signal conversion portion. After execution of the image processing, the AFE 52 outputs the image data output from the image processing portion to the control portion 7.

The operation display portion 6 is a user interface of the image forming apparatus 100. The operation display portion 6 includes a display portion and an operation portion. The display portion displays various types of information in response to control instructions from the control portion 7. For example, the display portion is a flat panel display such as a liquid crystal display. The operation portion inputs various types of information to the control portion 7 in response to a user operation. For example, the operation portion includes operation keys and a touch panel.

The control portion 7 performs overall control of the image forming apparatus 100. As shown in FIG. 3, the control portion 7 includes a CPU 61, a ROM 62, and a RAM 63. The CPU 61 is a processor that executes various types of arithmetic processing. The ROM 62 is a non-volatile storage device in which information such as control programs for causing the CPU 61 to execute various types of processes is stored in advance. The RAM 63 is a volatile or non-volatile storage device used as a temporary storage memory (work area) for various types of processes executed by the CPU 61. The CPU 61 performs overall control of the image forming apparatus 100 by executing various types of control programs pre-stored in the ROM 62.

An image forming apparatus is known that uses the recording head 30 to print a predetermined test pattern, and acquires the inclination of the recording head 30 based on a human or machine evaluation of the printing result of the test pattern.

Here, it is desirable that the test pattern be an image that allows the degree of inclination of the recording head 30 to be easily recognized.

On the other hand, the image forming apparatus 100 of an embodiment according to the present disclosure is capable of outputting an image that allows the degree of inclination of the recording head 30 to be easily recognized, as will be described below.

### Configuration of Control Portion 7

Next, a configuration of the control portion 7 will be described with reference to FIG. 3.

As shown in FIG. 3, the control portion 7 includes a first formation processing portion 64, a second formation processing portion 65, a reading processing portion 66, and an acquisition processing portion 67.

More specifically, the ROM 62 of the control portion 7 stores in advance an inclination angle acquisition program for causing the CPU 61 to function as each of the above-mentioned processing portions. The CPU 61, by executing the inclination angle acquisition program stored in the ROM 62, functions as each of the above-mentioned processing portions.

The inclination angle acquisition program may be recorded on a computer-readable recording medium such as a CD, DVD, or flash memory, and may be read from the recording medium and stored in a storage device provided in the image forming apparatus 100. In addition, some or all of the processing portions included in the control portion 7 may be configured with electronic circuits. Moreover, the inclination angle acquisition program may be a program for causing a plurality of processors to function as the processing portions included in the control portion 7.

The first formation processing portion 64 alternately ejects ink from the first nozzles of the plurality of nozzles 30A that are located farther on one side in the conveying direction D11 than two adjacent nozzles adjacent to each other in the width direction D12, and second nozzles of either of the two adjacent nozzles, thereby forming first line images IM1 (see FIG. 4) along the conveying direction D11 on the sheet.

For example, the first nozzles are nozzles 30A included in the first nozzle row L11 (see FIG. 4). In addition, the second nozzles are nozzles 30A included in the second nozzle row L12 (see FIG. 4).

For example, the first formation processing portion 64 forms the first line images IM1 arranged at equal intervals along the width direction D12. For example, the first formation processing portion 64 forms the first line images IM1 arranged at equal intervals along the width direction D12 using all the nozzles 30A included in the first nozzle row L11 and all the nozzles 30A included in the second nozzle row L12.

The second formation processing portion 65 alternately ejects ink from the first nozzles and the third nozzles, which are either of the two adjacent nozzles and different from the second nozzles, to form second line images IM2 (see FIG. 4) on the sheet along the conveying direction D11.

For example, the third nozzles are nozzles 30A included in the third nozzle row L13 (see FIG. 4).

For example, the second formation processing portion 65 forms the second line images IM2 arranged at equal intervals along the width direction D12. For example, the second formation processing portion 65 forms the second line images IM2 arranged at equal intervals along the width direction D12 using all the nozzles 30A included in the first nozzle row L11 and all the nozzles 30A included in the third nozzle row L13.

The reading processing portion 66 reads the first line images IM1 and the second line images IM2 formed on the sheet.

For example, the reading processing unit 66 uses the image reading portion 5 to read the first line images IM1 and the second line images IM2 formed on the sheet.

Note that the reading processing portion 66 may read the first line images IM1 and the second line images IM2 formed on the sheet using a scanner communicably connected to the image forming apparatus 100.

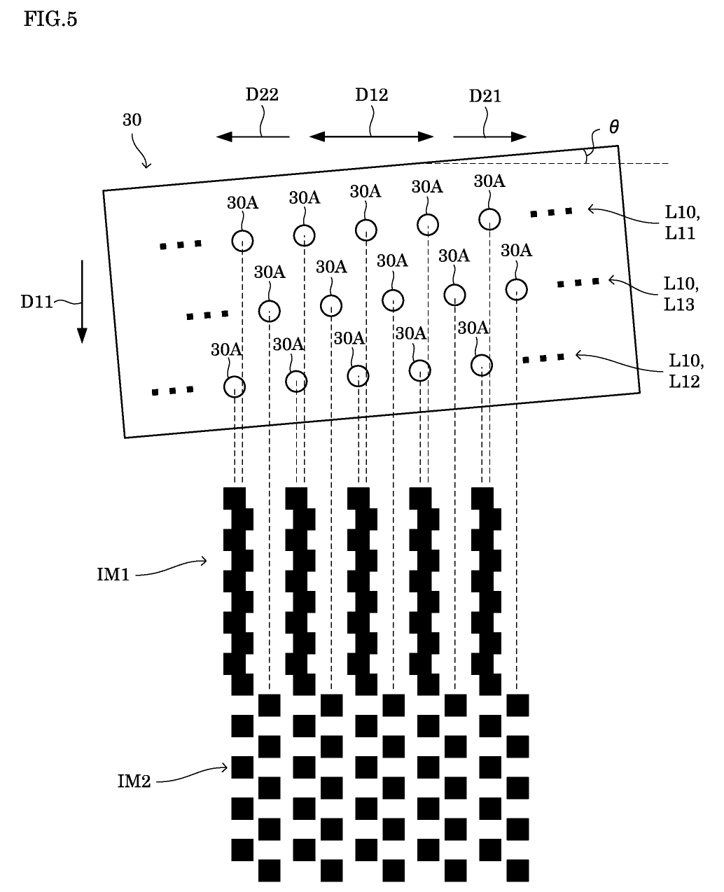

The acquisition processing portion 67 acquires an inclination angle θ (see FIG. 5) of the recording head 30 with respect to the width direction D12 based on a result of reading by the reading processing portion 66.

FIG. 5 shows the recording head 30 in a state of being inclined with respect to the width direction D12. More specifically, FIG. 5 shows the recording head 30 inclined with respect to the width direction D12 so that an end of the recording head 30 in the first direction D21 is located farther on the upstream side of the conveying direction D11 than the end of the recording head 30 in the second direction D22 (see FIG. 5), opposite to the first direction D21. In the present specification, in a case in which the recording head 30 is inclined as shown in FIG. 5, the sign of the inclination angle θ (see FIG. 5) of the recording head 30 with respect to the width direction D12 is assumed to be negative.

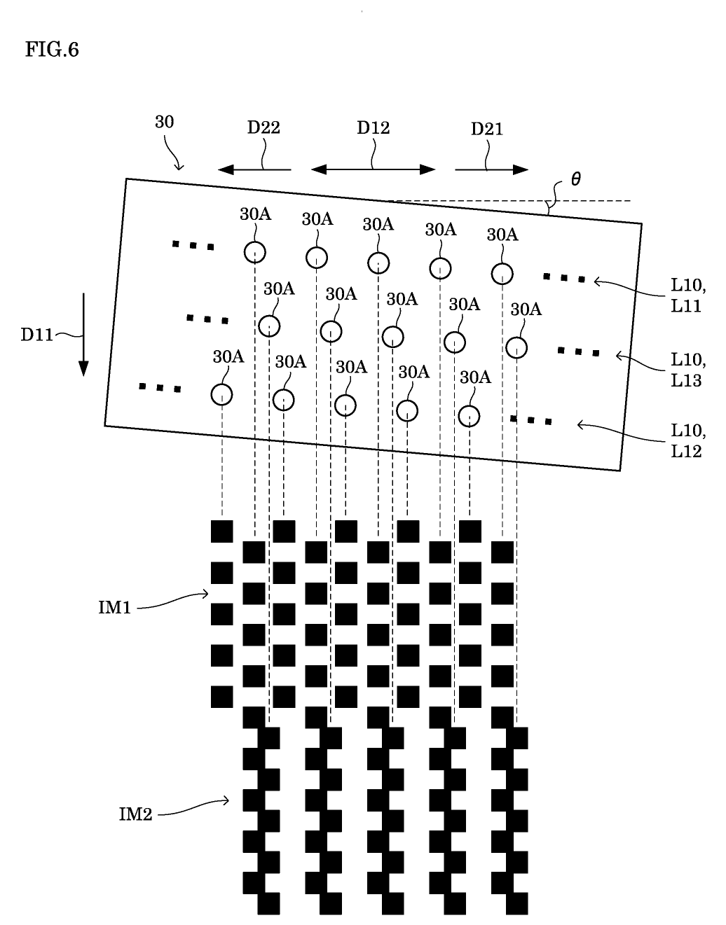

In addition, FIG. 6 shows the recording head 30 in a state of being inclined with respect to the width direction D12. More specifically, FIG. 6 shows the recording head 30 in a state inclined with respect to the width direction D12 so that the end of the recording head 30 in the first direction D21 is located farther on the downstream side in the conveying direction D11 than the end of the recording head 30 in the second direction D22. In the present specification, in a case in which the recording head 30 is inclined as shown in FIG. 6, the sign of the inclination angle θ (see FIG. 6) of the recording head 30 with respect to the width direction D12 is assumed to be positive.

Note that FIG. 4 shows the recording head 30 in a state of the inclination angle θ being zero.

As shown in FIG. 5, in a case in which the inclination angle θ is a negative value, an interval between the first nozzles and the second nozzles in the width direction D12 becomes narrower. Therefore, the width of the first line images IM1 becomes narrower than when the inclination angle θ is zero (see FIG. 4). In addition, as shown in FIG. 5, in a case in which the inclination angle θ is a negative value, an interval between the first nozzles and the third nozzles in the width direction D12 becomes wider. Therefore, the width of the second line images IM2 becomes wider than when the inclination angle θ is zero (see FIG. 4). In other words, in a case in which the width of the second line images IM2 is greater than the width of the first line images IM1, it is possible to determine that the sign of the inclination angle θ is negative. In addition, the inclination angle θ can be determined based on the width of the second line images IM2, the width of the first line images IM1, or a ratio between the width of the second line images IM2 and the width of the first line images IM1.

As shown in FIG. 6, in a case in which the inclination angle θ is a positive value, the interval between the first nozzles and the second nozzles in the width direction D12 becomes wider. Therefore, the width of the first line images IM1 becomes wider than when the inclination angle θ is zero (see FIG. 4). In addition, as shown in FIG. 6, in a case in which the inclination angle θ is a positive value, the interval between the first nozzles and the third nozzles in the width direction D12 becomes narrower. Therefore, the width of the second line images IM2 is narrower than when the inclination angle θ is zero (see FIG. 4). In other words, in a case in which the width of the second line images IM2 is narrower than the width of the first line images IM1, it is possible to determine that the sign of the inclination angle θ is positive. In addition, the inclination angle θ can be determined based on the width of the second line images IM2, the width of the first line images IM1, or a ratio between the width of the second line images IM2 and the width of the first line images IM1.

Here, in the image forming apparatus 100, the first formation processing portion 64 forms first line images IM1 that are arranged at equal intervals along the width direction D12. That is, in the image forming apparatus 100, a rectangular first area including the first line images IM1 arranged at equal intervals along the width direction D12 is formed. The first area is recognized as a monochrome area by a person or by the image reading portion 5, the reading resolution of which is lower than the printing resolution of the image forming portion 3. When the width of the first line images IM1 included in the first area becomes narrower, the density of the first area recognized by a person or the image reading portion 5 becomes lower. In addition, when the width of the first line images IM1 included in the first area becomes wider, the density of the first area recognized by a person or the image reading portion 5 becomes higher.

Moreover, in the image forming apparatus 100, the second formation processing portion 65 forms second line images IM2 that are arranged at equal intervals along the width direction D12. That is, in the image forming apparatus 100, a rectangular second area including second line images IM2 arranged at equal intervals along the width direction D12 is formed. The second area is recognized as a monochrome area by a person or by the image reading portion 5, the reading resolution of which is lower than the printing resolution of the image forming portion 3. When the width of the second line images IM2 included in the second area becomes narrower, the density of the second area recognized by a person or the image reading portion 5 becomes lower. In addition, when the width of the second line images IM2 included in the second area becomes wider, the density of the second area recognized by a person or the image reading portion 5 becomes higher.

That is, in a case in which the density of the first area is lower than the density of the second area (see FIG. 5), it is possible to determine that the sign of the inclination angle θ is negative. In addition, in a case in which the density of the first area is higher than the density of the second area (see FIG. 6), it is possible to determine that the sign of the inclination angle θ is positive. Moreover, the inclination angle θ can be determined based on the density of the first area, the density of the second area, or a ratio of the density of the first area to the density of the second area.

For example, the acquisition processing portion 67 detects the density of the first area based on a reading result by the reading processing portion 66. In addition, the acquisition processing portion 67 detects the density of the second area based on the reading result by the reading processing portion 66. The acquisition processing portion 67 acquires the inclination angle θ based on the detected density of the first area and the density of the second area. For example, the acquisition processing portion 67 acquires the inclination angle θ using table data indicating the correspondence between a ratio of the density of the first area to the density of the second area and the inclination angle θ. Note that the table data may be stored in advance in the ROM 62 of the control portion 7.

Note that the acquisition processing portion 67 may acquire the inclination angle θ based on the width of the first line images IM1 and the width of the second line images IM2 detected based on the reading result by the reading processing portion 66. In that case, the first formation processing portion 64 only needs to form at least one first line image IM1. In addition, the second formation processing portion 65 only needs to form at least one second line image IM2. Moreover, the reading resolution of the image reading portion 5 does not need to be lower than the printing resolution of the image forming portion 3.

### Inclination Angle Acquisition Process

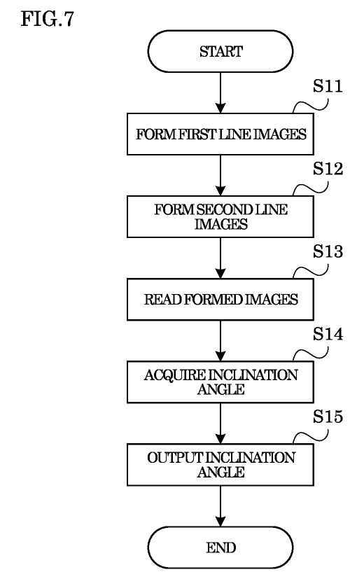

Hereinafter, with reference to FIG. 7, an example of a procedure of the inclination angle acquisition process executed by the control portion 7 in the image forming apparatus 100, and an image forming method and orientation adjustment method according to the present disclosure will be described. Here, steps S11, S12, . . . represent numbers of processing procedures (steps) executed by the control portion 7.

For example, the inclination angle acquisition process is executed in a case in which an instruction to execute the inclination angle acquisition process is input via the operation display portion 6. For example, the inclination angle acquisition process is executed for any one of the recording heads 30 designated by the user.

### Step S11

First, in step S11, the control portion 7 forms first line images IM1 on a sheet being conveyed by the sheet conveying portion 2. The process of step S11 is an example of a first formation step according to the present disclosure, and is executed by the first formation processing portion 64 of the control portion 7.

More specifically, the control portion 7 uses all the nozzles 30A included in the first nozzle row L11 (see FIG. 4) and all the nozzles 30A included in the second nozzle row L12 (see FIG. 4) to form the first area including the first line images IM1 arranged at equal intervals along the width direction D12.

### Step S12

In step S12, the control portion 7 forms second line images IM2 on the sheet on which the first line images IM1 have been formed by the process of step S11. The process of step S12 is an example of a second formation step according to the present disclosure, and is executed by the second formation processing portion 65 of the control portion 7.

More specifically, the control portion 7 uses all the nozzles 30A included in the first nozzle row L11 (see FIG. 4) and all the nozzles 30A included in the third nozzle row L13 (see FIG. 4) to form the second area including the second line images IM2 arranged at equal intervals along the width direction D12.

### Step S13

In step S13, the control portion 7 reads the first line images IM1 formed on the sheet by the processing in step S11, and the second line images IM2 formed on the sheet by the processing in step S12. The processing in step S13 is executed by the reading processing portion 66 of the control portion 7.

More specifically, the control portion 7 uses the image reading portion 5 to read the first area and the second area formed on the sheet.

### Step S14

In step S14, the control portion 7 acquires the inclination angle θ (see FIG. 5) of the recording head 30 with respect to the width direction D12 based on the reading result from the processing in step S13. The processing in step S14 is executed by the acquisition processing portion 67 of the control portion 7. The processing in steps S13 and S14 is an example of an acquisition step according to the present disclosure.

More specifically, the control portion 7 detects the density of the first area and the density of the second area based on the reading result in the processing in step S13. The control portion 7 acquires the inclination angle θ using the detected densities of the first and second areas and the table data.

### Step S15

In step S15, the control portion 7 outputs the inclination angle θ acquired in the processing in step S14.

For example, the control portion 7 causes the operation display portion 6 to display the inclination angle θ acquired in the processing in step S14. Thus, the operator adjusting the orientation of the recording head 30 is able to recognize the inclination angle θ. Therefore, the operator can adjust the orientation of the recording head 30 based on the inclination angle θ acquired in the processing in step S14. The process of adjusting the orientation of the recording head 30 executed by the operator is an example of an adjustment step according to the present disclosure.

In this manner, the image forming apparatus 100 can output images (the first line images IM1 and the second line images IM2) that allow the degree of inclination of the recording head 30 to be easily recognized.

In addition, in the image forming apparatus 100, first line images IM1 arranged at equal intervals along the width direction D12, and second line images IM2 arranged at equal intervals along the width direction D12 are formed on the sheet. Thus, the degree of inclination of the recording head 30 is expressed by the ratio between the density of the first area and the density of the second area. This makes it easier to recognize the degree of inclination of the recording head 30.

The adjustment step according to the present disclosure may be executed by the control portion 7. In this case, the image forming apparatus 100 may be provided with an adjustment mechanism capable of adjusting the orientation of the recording head 30. In addition, the control portion 7 may adjust the orientation of the recording head 30 using the adjustment mechanism.

Moreover, the acquisition step according to the present disclosure may be performed by a person (a worker). In this case, the image forming apparatus 100 does not need to include the image reading portion 5, the reading processing portion 66, and the acquisition processing portion 67.

In addition, the second nozzles may be the nozzles 30A included in the third nozzle row L13. In this case, the third nozzles are the nozzles 30A included in the second nozzle row L12.

Further, the first nozzles may be the nozzles 30A included in the second nozzle row L12. In this case, the nozzles 30A included in the first nozzle row L11 are either the second nozzles or the third nozzles.

In addition, the number of nozzle rows L10 included in the recording head 30 may be at least two or more.

### Supplementary Notes

An outline of the invention extracted from the above-described embodiments will be added below. The configurations and processing functions described in the following supplementary notes can be selected and combined as desired.

### Supplementary Note 1

An image forming apparatus including:

an ejection portion having a plurality of nozzles arranged along a width direction perpendicular to a conveying direction of a recording medium, and configured to eject ink from each of the nozzles toward the recording medium;

a first formation processing portion configured to alternately eject the ink from first nozzles of the plurality of nozzles located farther on one side in the conveying direction than two adjacent nozzles adjacent to each other in the width direction and second nozzles of either one of the two adjacent nozzles, thereby forming first line images along the conveying direction on the recording medium; and

a second formation processing portion configured to alternately eject the ink from the first nozzles and third nozzles that are one of the two adjacent nozzles and different from the second nozzles, to form second line images along the conveying direction on the recording medium.

### Supplementary Note 2

The image forming apparatus according to Supplementary Note 1, wherein

the first formation processing portion forms the first line images arranged at equal intervals along the width direction; and

the second formation processing portion forms the second line images arranged at equal intervals along the width direction.

### Supplementary Note 3

The image forming apparatus according to Supplementary Note 1 or 2, further including:

a reading processing portion configured to read the first line images and the second line images formed on the recording medium; and

an acquisition processing portion configured to acquire an inclination angle of the ejection portion with respect to the width direction based on a reading result by the reading processing portion.

### Supplementary Note 4

An orientation adjustment method executed using the image forming apparatus according to Supplementary Note 1 or 2;

the orientation adjustment method including:

an acquisition step of acquiring an inclination angle of the ejection portion with respect to the width direction based on the first line images and the second line images formed on the recording medium; and

an adjustment step of adjusting orientation of the ejection portion based on an acquisition result in the acquisition step.

### Supplementary Note 5

An image forming method executed by an image forming apparatus including an ejection portion having a plurality of nozzles arranged along a width direction perpendicular to a conveying direction of a recording medium, and configured to eject ink from each of the nozzles toward the recording medium;

the image forming method including:

a first formation step of alternately ejecting the ink from first nozzles of the plurality of nozzles located farther on one side in the conveying direction than two adjacent nozzles adjacent to each other in the width direction and second nozzles of either one of the two adjacent nozzles, thereby forming first line images along the conveying direction on the recording medium; and

a second formation step of alternately ejecting the ink from the first nozzles and third nozzles that are one of the two adjacent nozzles and different from the second nozzles, to form second line images along the conveying direction on the recording medium.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an ejection portion having a plurality of nozzles arranged along a width direction perpendicular to a conveying direction of a recording medium, and configured to eject ink from each of the nozzles toward the recording medium;
a first formation processing portion configured to alternately eject the ink from first nozzles of the plurality of nozzles located farther on one side in the conveying direction than two adjacent nozzles adjacent to each other in the width direction and second nozzles of either one of the two adjacent nozzles, thereby forming first line images along the conveying direction on the recording medium; and
a second formation processing portion configured to alternately eject the ink from the first nozzles and third nozzles that are one of the two adjacent nozzles and different from the second nozzles, to form second line images along the conveying direction on the recording medium.

2. The image forming apparatus according to claim 1, wherein
the first formation processing portion forms the first line images arranged at equal intervals along the width direction; and
the second formation processing portion forms the second line images arranged at equal intervals along the width direction.

3. The image forming apparatus according to claim 1, further including:
a reading processing portion configured to read the first line images and the second line images formed on the recording medium; and
an acquisition processing portion configured to acquire an inclination angle of the ejection portion with respect to the width direction based on a reading result by the reading processing portion.

4. An orientation adjustment method executed using an image forming apparatus according to claim 1;
the orientation adjustment method comprising:
an acquisition step of acquiring an inclination angle of the ejection portion with respect to the width direction based on the first line images and the second line images formed on the recording medium; and
an adjustment step of adjusting orientation of the ejection portion based on an acquisition result in the acquisition step.

5. An image forming method executed by an image forming apparatus comprising an ejection portion having a plurality of nozzles arranged along a width direction perpendicular to a conveying direction of a recording medium, and configured to eject ink from each of the nozzles toward the recording medium;
the image forming method, comprising:
a first formation step of alternately ejecting the ink from first nozzles of the plurality of nozzles located farther on one side in the conveying direction than two adjacent nozzles adjacent to each other in the width direction and second nozzles of either one of the two adjacent nozzles, thereby forming first line images along the conveying direction on the recording medium; and
a second formation step of alternately ejecting the ink from the first nozzles and third nozzles that are one of the two adjacent nozzles and different from the second nozzles, to form second line images along the conveying direction on the recording medium.
